(19) United States
(12) Patent Application Publication
(10) Pub. No.: US 2017/0329084 A1
(43) Pub. Date: Nov. 16, 2017

(54) POLARIZATION DEPENDENT LOSS CONTROL FOR POLARIZATION DIVERSE CIRCUIT

(71) Applicants: Dominic John Goodwill, Ottawa (CA); Patrick Dumais, Ottawa (CA)

(72) Inventors: Dominic John Goodwill, Ottawa (CA); Patrick Dumais, Ottawa (CA)

(21) Appl. No.: 15/154,601

(22) Filed: May 13, 2016

(51) Int. Cl. G02B 6/27; G02B 27/28

(52) U.S. Cl. CPC G02B 6/2793; G02B 27/283; G02B 6/272; G02B 6/2766; G02B 6/2773; G02B 27/286

(57) ABSTRACT

An optical apparatus for compensating a measurement inaccuracy of polarization dependent loss (PDL) is described. The apparatus comprises a first polarization rotator splitter (PRS) for splitting an input beam into orthogonally polarized X and Y component beams and rotating one of the X and Y component beams to be in the same polarization as the other component beam; first and second circuits for processing the X and Y component beams respectively; a first polarization rotator combiner (PRC) for combining the X and Y component beams processed respectively by the first and second circuits into an output beam, one of the X and Y component beams being rotated to be orthogonally polarized with respect to the other component beam. The apparatus further comprises a first set of photodetectors for monitoring a first relative power between the X and Y component beams before the first and second circuits; a second set of photodetectors for monitoring a second relative power between the X and Y component beams processed respectively by the first and second circuits; and complementary PRSs and PRCs coupled between the first and second circuits and the second set of photo-detectors for compensating a measurement inaccuracy of PDL caused by the first PRS and PRC.

### TECHNICAL FIELD

The present disclosure relates to an apparatus and method for polarization dependent loss control, and more particularly, to an apparatus and method for polarization dependent loss control for a polarization diverse circuit.

### BACKGROUND

Semiconductor photonics, such as silicon or indium phosphide photonics, often exhibit polarization dependent properties. Polarization dependent loss (PDL) and/or gain is a critical parameter to control in a photonic integrated circuit (PIC). Low PDL (for example, less than 0.3 dB) can be difficult to achieve.

In a PIC with polarization diversity, a polarization rotator splitter (PRS) may be provided for splitting light at orthogonal polarizations to propagate along physically different paths, and a polarization rotator combiner (PRC) may be provided for recombining the light propagated along the different paths. Orthogonally polarized component beams X, Y are handled by separate circuits, each operating in a single state of polarization. However, it is difficult to control the balance between the PRS and PRC in such a polarization diverse circuit. As well, an optimal PRS can be significantly different from an optimal PRC. The PRS and PRC can respond differently to manufacturing variations, contributing to an unknown measurement inaccuracy of PDL that can be different from wafer to wafer.

It is therefore desirable to provide an optical apparatus with improved polarization diversity.

### SUMMARY

The following presents a summary of some aspects or embodiments of the disclosure in order to provide a basic understanding of the disclosure. This summary is not an extensive overview of the disclosure. It is not intended to identify key or critical elements of the disclosure or to delineate the scope of the disclosure. Its sole purpose is to present some embodiments of the disclosure in a simplified form as a prelude to the more detailed description that is presented later.

In accordance with one aspect of the disclosure, there is provided an optical apparatus for compensating a measurement inaccuracy of polarization dependent loss (PDL). The apparatus comprises a first polarization rotator splitter (PRS) for splitting an input beam into orthogonally polarized X and Y component beams and rotating one of the X and Y component beams to be in the same polarization as the other component beam; first and second circuits for processing the X and Y component beams respectively; a first polarization rotator combiner (PRC) for combining the X and Y component beams processed respectively by the first and second circuits into an output beam, one of the X and Y component beams being rotated to be orthogonally polarized with respect to the other component beam. The apparatus further comprises a first set of photodetectors for monitoring a first relative power between the X and Y component beams before the first and second circuits; a second set of photodetectors for monitoring a second relative power between the X and Y component beams processed respectively by the first and second circuits; and complementary PRSs and PRCs coupled between the first and second circuits and the second set of photo-detectors for compensating a measurement inaccuracy of PDL caused by the first PRS and PRC.

In accordance with another aspect of the disclosure, there is provided a method of compensating a measurement inaccuracy of polarization dependent loss (PDL) in a polarization diverse circuit. The method comprises splitting, by a first polarization rotator splitter (PRS), an input beam into orthogonally polarized X and Y component beams, one of the X and Y component beams being rotated to be in the same polarization as the other component beam; monitoring a first relative power between the X and Y component beams before processing; processing the X and Y component beams separately; monitoring a second relative power between the X and Y component beams after processing; and combining, by a first polarization rotator combiner (PRC), the X and Y component beams processed by the first and second circuits into an output beam, one of the X and Y component beams being rotated to be orthogonally polarized with respect to the other component beam, wherein a measurement inaccuracy of PDL caused by the first PRS and PRC is compensated by complementary PRSs and PRCs.

### BRIEF DESCRIPTION OF THE DRAWINGS

These and other features of the disclosure will become more apparent from the description in which reference is made to the following appended drawings.

FIG. 1 is a schematic diagram of an optical apparatus for compensating a measurement inaccuracy of polarization dependent loss (PDL), according to an embodiment of the disclosure.

FIG. 2 is a schematic diagram explaining the principle of PDL control in a polarization diverse circuit, according to an embodiment of the disclosure.

FIG. 3 is a schematic diagram illustrating the various symbols used in the PDL measurement.

FIG. 4 is a functional block diagram of a control circuit, according to an embodiment of the disclosure.

FIG. 5 is a schematic diagram of an optical apparatus for compensating a measurement inaccuracy of PDL, according to an alternative embodiment of the disclosure.

FIG. 6 is a schematic diagram of an optical apparatus for compensating a measurement inaccuracy of PDL, according to another alternative embodiment of the disclosure.

FIG. 7 is a schematic diagram of an optical apparatus for compensating a measurement inaccuracy of PDL, according to yet another alternative embodiment of the disclosure.

FIG. 8 is a schematic diagram of an optical apparatus for compensating a measurement inaccuracy of PDL, according to yet another alternative embodiment of the disclosure.

FIG. 9A is a floor plan illustrating an output section of a conventional optical apparatus after X, Y processing.

FIG. 9B is a floor plan illustrating an output section of an optical apparatus after X, Y processing, according to an embodiment of the disclosure.

FIG. 10 is a method of compensating a measurement inaccuracy of PDL in a polarization diverse circuit, according to an embodiment of the disclosure.

### DETAILED DESCRIPTION

The following detailed description contains, for the purposes of explanation, various illustrative embodiments, implementations, examples and specific details in order to provide a thorough understanding of the disclosure. It is apparent, however, that the disclosed embodiments may be practiced, in some instances, without these specific details or with an equivalent arrangement. The description should in no way be limited to the illustrative implementations, drawings, and techniques illustrated below, including the exemplary designs and implementations illustrated and described herein, but may be modified within the scope of the appended claims along with their full scope of equivalents.

Disclosed herein are optical apparatuses and methods of compensating a measurement inaccuracy of polarization dependent loss (PDL), in a polarization diverse circuit.

There is a desire to build photonic integrated circuits (PICs) with polarization diversity. One way to achieve polarization diversity is to split light into two orthogonally polarized component beams by a polarization splitter (PS). The two component beams are referred to as X and Y component beams. One of the components, for example the X component, may be coupled into the photonic chip as a Transverse Electrical (TE) mode, and the other component, for example the Y component, may be coupled into the photonic chip as a Transverse Magnetic (TM) mode. The PS can be used with a polarization rotator (PR), where one of the component beams can be rotated by the PR so that both component beams can be in the same mode, be it TE or TM. The PS and PR collectively is referred to as a polarization rotator splitter (PRS). After performing desired operations separately for the two component beams, one component beam can be rotated again by another PR, and combined with the other component beam by a polarization combiner (PC). The PR and PC collectively is referred to as a polarization rotator combiner (PRC).

By way of the PRS and PRC, a photonic circuit can be a polarization diverse circuit, where X and Y component beams can be handled by nominally identical circuits, both operating in the same polarization (such as TE). Photodetectors can be placed on the X and Y component beams at the start and end of the polarization diverse circuit to monitor powers of the X and Y component beams. The PDL of the polarization diverse circuit can be controlled when a balance is maintained between an input power ratio of the X and Y component beams and an output power ratio of the X and Y component beams.

As will be explained below, conventional PDL measurements in a polarization diverse circuit may not compensate for any imbalance between the PRS and PRC in the polarization diverse circuit. On the same die, one may manufacture almost identical PRSs and identical PRCs, within a variation of as small as e.g., less than 0.1 dB. However, a PRS can be different from a PRC, and the relative performance between the PRS and PRC may not be well controlled. The variation between PRS and PRC can be larger than 0.1 dB, and can use up a desired PDL budget of a photonic chip.

In theory PRS and PRC can be nominally identical devices, merely used in opposite directions to achieve the PRS or PRC function. However, in real photonic circuits, PRS and PRC are not reciprocal. For example, to achieve sufficient crosstalk suppression, sometimes as high as around 35 dB, the PRS and PRC can be optimized differently. The two inputs to the PRC come from X and Y circuits respectively and the relative phase of the light coming from these circuits is not controlled. As well, the interference effects would not be the same when used in opposite directions, because the relative phase of the light entering the two inputs of the PRC affects where the light goes. An optimum PRS may therefore be significantly different from an optimum PRC. As a result, in real photonic circuits, the PRS and PRC can respond differently to manufacturing variations, contributing to an unknown measurement inaccuracy of PDL that can be different from wafer to wafer.

For the purpose of the disclosure, two optical devices are said to be “reciprocal” if the two optical devices are otherwise identical (or within a negligible variation), but for the direction of use. An optical device (or a channel of the optical device) is said to be “reciprocal” if the input and output of the optical device (or of the channel) can be swapped or flipped without affecting the performance (or with a negligible variation).

The optical apparatus according to various embodiments provides a photonic circuit that incorporates a self-compensation of the measurement inaccuracy of PDL introduced by the imbalance between the PRS and PRC, which can vary from die to die. The disclosed optical apparatus enables a more accurate control of PDL accounting for the relative power loss/gain between X and Y component beams introduced by the PSR and the relative power loss/gain between X and Y component beams introduced by the PRC.

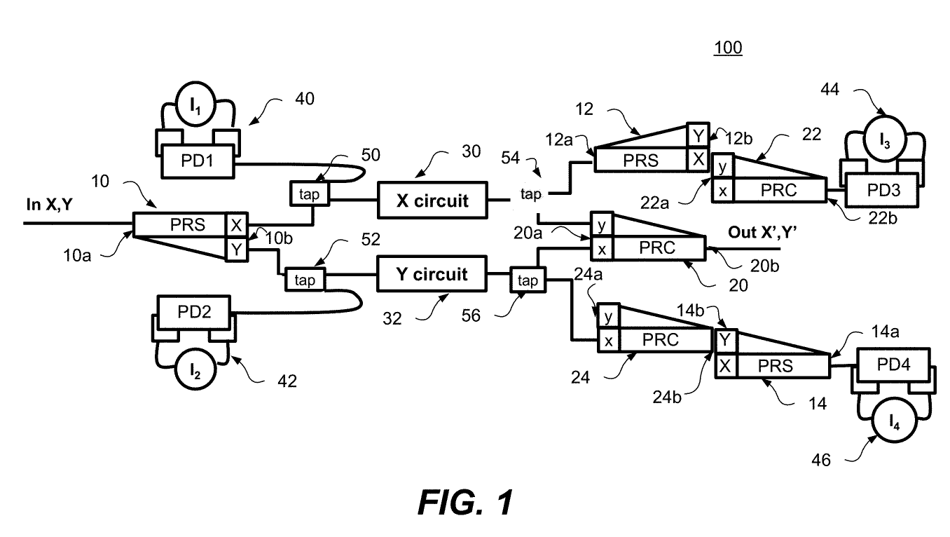

A schematic diagram of an optical apparatus 100 according to an embodiment of the disclosure is shown in FIG. 1.

The optical apparatus 100 includes a first PRS 10, a first PRC 20, and two separate circuits, namely, a first circuit 30 (X circuit) for processing the X component beam (X processing) and a second circuit 32 (Y circuit) for processing the Y component beam (Y processing), coupled between the first PRS 10 and the first PRC 20.

The first PRS 10 splits an input beam into orthogonally polarized X and Y component beams. One of the X and Y component beams can be rotated to be in the same polarization as the other component beam. For example, the X component beam can be coupled to the photonic chip in TE mode and the Y component beam in TM mode. The first PRS 10 then rotates the Y component beam to be in TE mode and outputs both X, Y component beams in TE mode. All subsequent devices in the photonic diverse circuit operate in the same mode (e.g., TE) as the output mode of the PRS, until the component beam is rotated again.

The first PRC 20 combines the X and Y component beams processed respectively by the first and second circuits 30, 32 into an output beam. One of the X and Y component beams can be rotated again to recover the dual polarization of the output beam. For example, the first PRC 20 can rotate the X component beam in TE mode to be in TM mode and combine it with the Y component beam in TE mode. By way of the first PRS 10 and the first PRC 20, the optical apparatus 100 enables a polarization diverse circuit where X and Y circuits 30, 32 can be nearly identical circuits, both operating in the same polarization (e.g., TE).

For purpose of simplicity, in many embodiments illustrated by way of the figures, the X component beam is referred to as the component beam that carries light in TE mode and the Y component beam is referred to as the component beam that carries light in TM mode. It should however be appreciated that the X component beam can be coupled to the photonic chip in TM mode, and the Y component beam can be coupled to the photonic chip in TE mode. In such a case, the PRS 10 can rotate the Y component beam to be in TM mode and output both X, Y component beams in TM mode, and the PRC 20 can rotate the X component beam to be in TE mode and combine it with the Y component beams in TM mode.

The optical apparatus 100 further includes a first set of photodetectors 40, 42 for monitoring a first relative power between the X and Y component beams before the first and second circuits 30, 32; and a second set of photodetectors 44, 46 for monitoring a second relative power between the X and Y component beams processed respectively by the first and second circuits 30, 32. More specifically, there are provided a first photodetector 40 for monitoring a power of the X component beam before the first circuit 30; a second photodetector 42 for monitoring a power of the Y component beam before the second circuit 32; a third photodetector 44 for monitoring a power of the X component beam processed by the first circuit 30; and a fourth photodetector 46 for monitoring a power of the Y component beam processed by the second circuit 32. As will be explained, the first relative power is used as an input power ratio between the X and Y component beams and the second relative power is used as an output power ratio between the X and Y component beams.

In the illustrated embodiments by way of the figures, each of the first, second, third and fourth photodetectors 40, 42, 44, 46 can include an optical tap 50, 52, 54, 56 coupled thereto for tapping a small fraction (e.g., 1%) of the light for detection or monitoring. Each photodetector can absorb a repeatable fraction (e.g., >99%) of the tapped light. A photodetector can be a photodiode. An optical tap can be a waveguide device such as a weak directional coupler.

Alternatively in another implementation, each of the first, second, third and fourth photodetectors 40, 42, 44, 46 can be an evanescent field monitor that is placed near the light path waveguide, such that a repeatable fraction of the light is absorbed by the photodetector.

According to various embodiments, complementary PRSs and PRCs 12, 22, 24, 14 are coupled between the first and second circuits 30, 32 and the second set of photo-detectors 44, 46 for compensating a measurement inaccuracy of PDL caused by the first PRS 10 and the first PRC 12. In particular, the complementary PRSs and PRCs include a second PRS 12 and a second PRC 22 coupled between the first circuit 30 and the third photodetector 44; and a third PRS 24 and a third PRC 14 coupled between the second circuit 32 and the fourth photodetector 46.

Each of the first, second, and third PRSs 10, 12, 14 includes an input port 10a, 12a, 14a, respectively, at one end, and X and Y output ports 10b, 12b, 14b, respectively, at the other end. Each of the first, second, and third PRCs 20, 22, 24 includes x and y input ports 20a, 22a, 24a, respectively, at one end and an output port 20b, 22b, 24b, respectively, at the other end.

In many embodiments illustrated by way of the figures, the first circuit 30 is coupled to the X output port 10b of the first PRS 10 and the y input port 20a of the first PRC 20, and the second circuit 32 is coupled to the Y output port 10b of the first PRS 10 and the x input port 20a of the first PRC 20.

In such embodiments, as will be explained below, the second PRS 12 and the second PRC 22 are arranged such that the X component beam travels through the X output port 12b of the second PRS 12 and the y input port 22a of the second PRC 22; and the Y component beam travels through the x input port 24a of the third PRC 24 and the Y output port 14b of the third PRS 14.

In the particular embodiment as illustrated in FIG. 1, the X component beam travels from the input port 12a of the second PRS 12 to the X output port 12b of the second PRS 12, and from the y input port 22a of the second PRC 22 to the output port 22b of the second PRC 22. Also, the Y component beam travels from the x input port 24a of the third PRC 24 to the output port 24b of the third PRC 24, and from the y output port 14b of the third PRS 14 to the input port 14a of the third PRS 14.

When the first PRS 10 outputs both X, Y component beams in TE mode, the X component beam goes through the second PRS 12 in TE mode and is rotated by the second PRC 22 to TM mode; and similarly, the Y component beam goes through the third PRC 24 in TE mode and is rotated by the third PRS 14 to TM mode. The first set of photodetectors 40, 42 are therefore TE photodetectors, and the second set of photodetectors 44, 46 are TM photodetectors. TE photodetectors can be identical to TM photodetectors, or different from TM photodetectors.

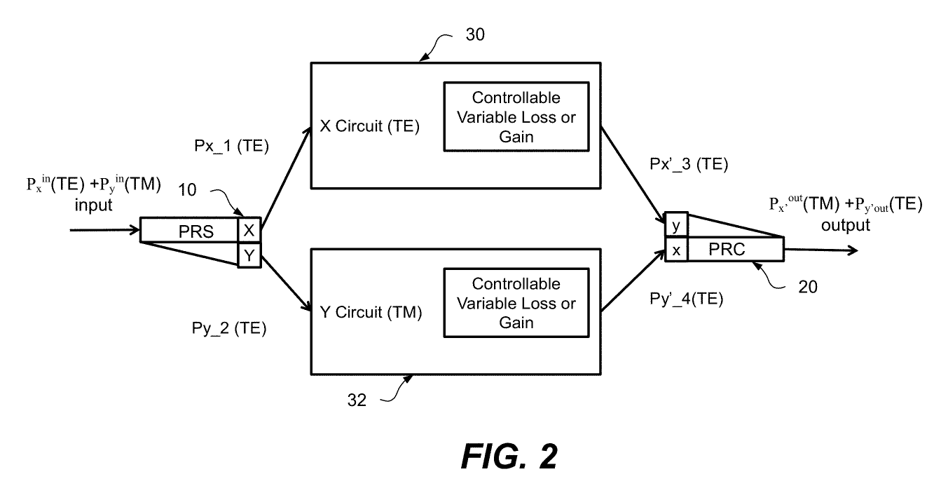

The principle of PDL measurement in a polarization diverse circuit will be explained with reference to FIG. 2.

An accurate measurement of the input power ratio of the X and Y component beams should ideally be obtained by measuring powers Pₓⁱⁿ, P_{y}ⁱⁿ of the X,Y component beams entering the circuit before the PRS 10. Similarly, an accurate measurement of the output power ratio of the X and Y component beams should ideally be obtained by measuring powers Pₓ^{out}, P_{y}^{out} of the X, Y component beams leaving the circuit after the PRC 20. In such an ideal situation, a relative loss/gain of the X and Y circuits 30, 32 can be controlled based on the ratio of Pₓ^{int}/P_{y}ⁱⁿ and the ratio of Pₓ^{out}/P_{y}^{out}. Attenuation and/or gain in the X and/or Y circuit can be adjusted such that Pₓⁱⁿ/P_{y}ⁱⁿ−Pₓ^{out}/P_{y}^{out} to control the PDL of the polarization diverse circuit.

However, in actual photonic circuits, for the input light, powers Px_1, Py_2 of the X, Y component beams after the PRC 10 are measured, instead of Pₓⁱⁿ, P_{y}ⁱⁿ. Similarly, for the output light, powers Px′_3, Py′_4 of the X, Y component beams before the PRC 20 are measured, instead of Pₓ^{out}, P_{y}^{out}. When these powers are used for the PDL control, it does not account for the imbalance introduced by the first PRS 10 and the first PRC 20.

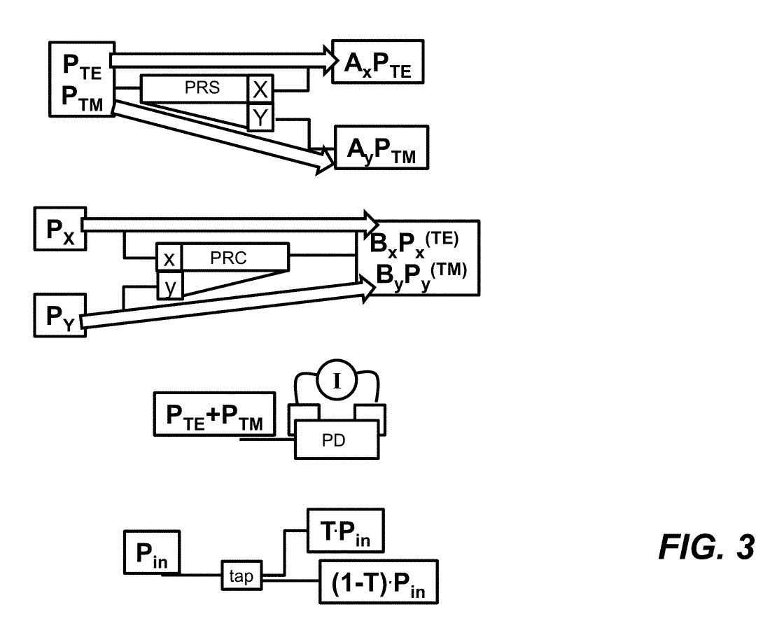

FIG. 3 is a schematic diagram illustrating the various symbols used in the PDL measurement, as explained below.

For a PRS 10, 12, 14 (FIG. 1), Aₓ (FIG. 3) represents the power loss/gain between the input port and the X output port. The channel between the input port and the X output port of a PRS is denoted as a X-X channel, for example, a TE-to-TE channel. A_{y} represents the power loss/gain between the input port and the Y output port. The channel between the input port and the Y output port of a PRS is denoted as a X-Y channel, for example, a TM-to-TE channel. The X-X channel is considered to be reciprocal; and because the X-Y channel contains a rotation of the component beam, e.g., from TM to TE, it is not considered to be reciprocal.

For a PRC 20, 22, 24, Bₓ represents the power loss/gain between the x input port and the output port. The channel between the x input port and the output port is denoted as a x-x channel, for example, a TE-to-TE channel. B_{y} represents the power loss/gain between the y input port and the output port. The channel between the y input port and the output port is denoted as a y-x channel, for example, a TE-to-TM channel. The x-x channel is considered to be reciprocal; and because the y-x channel contains a rotation of the component beam, e.g., from TE to TM, it is not considered to be reciprocal.

It should be noted that Aₓ, A_{y}, Bₓ, B_{y} only represent coefficients of the signal components, and not the crosstalk between channels. For a more efficient compensation of die-to-die manufacturing variations, the second and third PRSs 12, 14 and PRCs 22, 24 should be made substantially identical to the first PRS 10 and first PRC 20, respectively, i.e. the PRSs and PRCs should have identical respective characteristics Aₓ, A_{y}, Bₓ, B_{y}.

For a photodetector 40, 42, 44, 46, S_{TE} represents a responsivity coefficient for TE light, and S_{TM} represents a responsivity coefficient for TM light. The responsivity coefficients S_{TE}, S_{TM} are in unit of Amp (of current) per Watt (of optical power). The current I output by the photodetector satisfies the relationship I=P_{TE}S_{TE}+P_{TM}S_{TM}, where P_{TE} is the power of the TE component beam, and P_{TM} is the power of the TM component beam. The first, second, third and fourth photodetectors 40, 42, 44, 46 output photodetector currents I₁, I₂, I₃, I₄, respectively.

For the optical taps 50, 52, 54, 56, T represents a fraction of the light extracted from the light path using the tap. The remaining power (1−T)·Pᵢₙ goes through to the output, where Pᵢₙ is the input power of the optical tap.

For X and Y circuits 30, 32, Mₓ and M_{y} represent the loss/gain of the X and Y circuits, respectively.

Because variability between like devices (such as between PRSs 10, 12, 14, between PRCs 20, 22, 24, between photodetectors 40, 42, 44, 46, between optical taps 50, 52, 54, 56) on the same die can be assumed to be negligible compared to the target PDL, these like devices are treated as identical for the purpose of PDL measurement.

Assume the first PRS 10 outputs two TE component beams, the photodetector current I₁, I₂, I₃, I₄ satisfy the following relationships:

I₁=Pₓⁱⁿ AₓTS_{TE} (1)

I₂=P_{y}ⁱⁿ A_{y}TS_{TE} (2)

I₃=Pₓⁱⁿ Aₓ(1−T)MₓTA_{X}B_{y}S_{TM} (3)

I₄=P_{y}ⁱⁿ A_{y}(1−T)M_{y}TA_{y}BₓS_{TM} (4)

where Pₓⁱⁿ represents the input optical power of the X component beam entering the circuit before the PRS 10; and P_{y}ⁱⁿ represents the input optical power of the Y component beam entering the circuit before the PRS 10.

The ratio of input photodetector signals I₁/I₂, in terms of the input optical powers Pₓⁱⁿ, P_{y}ⁱⁿ can be expressed as:

$$\frac{{I}_{1}}{{I}_{2}} = \frac{{P}_{x}^{in} {A}_{x} {TS}_{TE}}{{P}_{y}^{in} {A}_{y} {TS}_{TE}} = \frac{{P}_{x}^{in} {A}_{x}}{{P}_{y}^{in} {A}_{y}} \qquad ( 5 )$$

The ratio of output photodetector signals I₃/I₄, in terms of the input optical powers Pₓⁱⁿ, P_{y}ⁱⁿ can be expressed as:

$$\begin{matrix}\frac{{I}_{3}}{{I}_{4}} = \frac{{P}_{x}^{in} {A}_{x} ( 1 - T ) {M}_{x} {TA}_{x} {B}_{y} {S}_{TM}}{{P}_{y}^{in} {A}_{y} ( 1 - T ) {M}_{y} {TA}_{y} {B}_{x} {S}_{TM}} \\ = \frac{{P}_{x}^{in} {A}_{x}^{2} {B}_{y} {M}_{x} {S}_{TM}}{{P}_{y}^{in} {A}_{y}^{2} {B}_{x} {M}_{y} {S}_{TM}} \\ = \frac{{P}_{x}^{in} {A}_{x} {B}_{y} {M}_{x}}{{P}_{y}^{in} {A}_{y} {B}_{x} {M}_{y}} \frac{{A}_{x} {S}_{TM}}{{A}_{y} {S}_{TM}}\end{matrix} \qquad ( 6 )$$

If Pₓ^{out} is the output optical power of the X component beam leaving the circuit after the PRC 20; and P_{y}^{out} is the output optical power of the Y component beam leaving the circuit after the PRC 20, the output optical powers Pₓ^{out}, P_{y}^{out}, in terms of the input optical powers Pₓⁱⁿ, P_{y}ⁱⁿ, can be expressed as:

$$\begin{matrix}{P}_{{x}^{′}}^{out} = {P}_{x}^{in} {A}_{x} {{B}_{y} ( 1 - T )}^{2} {M}_{x} & ( 7 ) \\ {P}_{{y}^{′}}^{out} {P}_{y}^{in} {A}_{y} {{B}_{x} ( 1 - T )}^{2} {M}_{y} & ( 8 ) \\ \frac{{P}_{{x}^{′}}^{out}}{{P}_{{y}^{′}}^{out}} = \frac{{P}_{x}^{in} {A}_{x} {B}_{y} {M}_{x}}{{P}_{y}^{in} {A}_{y} {B}_{x} {M}_{y}} & ( 9 )\end{matrix}$$

The ratio of output photodetector signals I₃/I₄, in terms of the output optical powers Pₓ^{out}, P_{y}^{out} can be expressed as:

$$\frac{{I}_{3}}{{I}_{4}} = \frac{{P}_{{x}^{′}}^{out}}{{P}_{{y}^{′}}^{out}} \frac{{A}_{x} {S}_{TM}}{{A}_{y} {S}_{TM}} = \frac{{P}_{{x}^{′}}^{out}}{{P}_{{y}^{′}}^{out}} \frac{{A}_{x}}{{A}_{y}} \qquad ( 10 )$$

As mentioned above, the ratio of photocurrents I₁/I₂ represents the first relative power between the X and Y component beams before the first and second circuits 30, 32, and the ratio of photocurrents I₃/I₄ represents a second relative power between the X and Y component beams processed by the first and second circuits 30, 32. Then a PDL error signal E can be represented as the ratio of the first relative power and the second relative power, expressed as:

$$E = ( \frac{{I}_{1}}{{I}_{2}} ) / ( \frac{{I}_{3}}{{I}_{4}} ) = ( \frac{{P}_{x}^{in} {A}_{x}}{{P}_{y}^{in} {A}_{y}} ) / ( \frac{{P}_{{x}^{′}}^{out} {A}_{x}}{{P}_{{y}^{′}}^{out} {A}_{y}} ) = ( \frac{{P}_{x}^{in}}{{P}_{y}^{in}} ) / ( \frac{{P}_{{x}^{′}}^{out}}{{P}_{{y}^{′}}^{out}} ) \qquad ( 11 )$$

It can be seen that the ratio of the first relative power and the second relative power accurately represents the ratio between the input power ratio Pₓⁱⁿ/P_{y}ⁱⁿ of the X and Y component beams and the output power ratio Pₓ^{out}/P_{y}^{out} of the X and Y component beams. When E=1, then

$$\frac{{P}_{x}^{in}}{{P}_{y}^{in}} = \frac{{P}_{{x}^{′}}^{out}}{{P}_{{y}^{′}}^{out}} \qquad ( 12 )$$

E can be adjusted to achieve E=1 by varying the attenuation and/or gain of the first and second circuits 30, 32, i.e., by varying Mₓ and/or M_{y}.

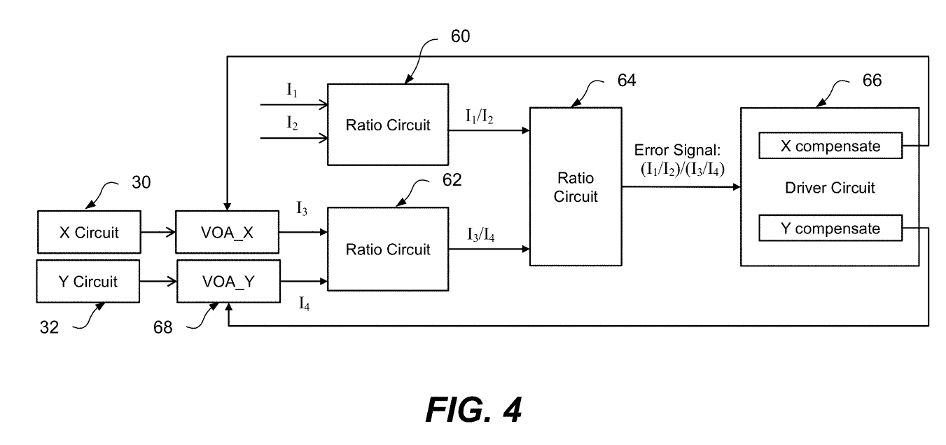

FIG. 4 is a functional block diagram of a control circuit, according to an embodiment of the disclosure.

According to the embodiment, the optical apparatus can include a control circuit for controlling the X and Y circuits 30, 32 to maintain a balance between the first relative power and the second relative power. The control circuit can include a first ratio circuit 60 for calculating the first relative power I₁/I₂ based on a ratio of the power of the X component beam before the first circuit 30 and the power of the Y component beam before the second circuit 32; and a second ratio circuit 62 for calculating the second relative power I₃/I₄ based on a ratio of the power of the X component beam processed by the first circuit 30 and the power of the Y component beam processed by the second circuit 32. A third ratio circuit 64 can be used for calculating a ratio of the first relative power and the second relative power producing the error signal E. Each of the first and second ratio circuits 60, 62 can include a pair of analog to digital converter (A/D) followed by a digital signal processor (DSP). The third ratio circuit 64 can include a DSP. The error signal E is used by a driver circuit 66 which in turn controls the variable loss/gain VOA_X, VOA_Y of the X, Y circuits 30, 32 to maintain E=1.

Input and output ratio circuits and feedbacks can already be included in a conventional polarization diverse circuit and no additional electrical circuit is therefore required. Input optical power ratio Pₓⁱⁿ/P_{y}ⁱⁿ may be time-varying, but because the control circuit is based on a ratio of two ratios, the error signal E is independent of Pₓⁱⁿ/P_{y}ⁱⁿ. For moments when Pₓⁱⁿ0 (I₁=I₃=0) or P_{y}ⁱⁿ=0 (I₂=I₄=0), the control circuit can lock itself and not change the compensation.

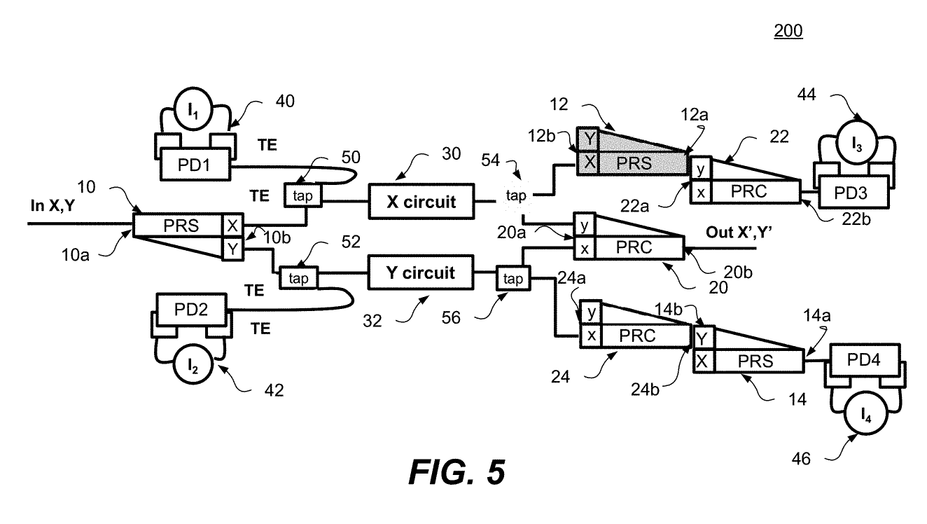

FIG. 5 is a schematic diagram of an optical apparatus 200 for compensating a measurement inaccuracy of PDL, according to an alternative embodiment of the disclosure.

The embodiment illustrated in FIG. 5 is similar to the embodiment illustrated in FIG. 1, except for the configuration of the second PRS 12. In the embodiment illustrated in FIG. 5, the X component beam travels from the X output port 12b of the second PRS 12 to the input port 12a of the second PRS 12, and from the y input port 22a of the second PRC 22 to the output port 22b of the second PRC 22. In other words, the input and output of the second PRS 12 are flipped or swapped. As explained above, this can be done because the X-X channel of a PRS is considered to be reciprocal.

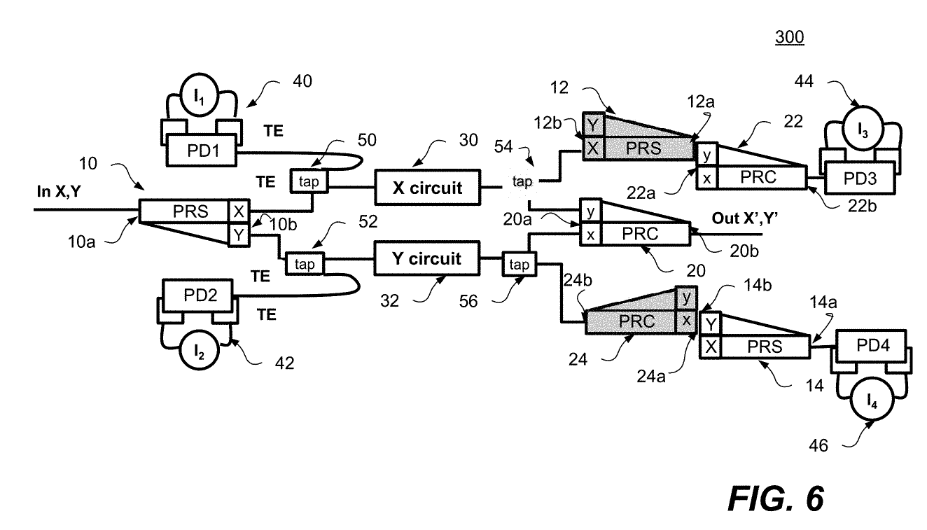

FIG. 6 is a schematic diagram of an optical apparatus 300 for compensating a measurement inaccuracy of PDL, according to another alternative embodiment of the disclosure.

Similar to FIG. 5, the X component beam travels from the X output port 12b of the second PRS 12 to the input port 12a of the second PRS 12, and from the y input port 22a of the second PRC 22 to the output port 22b of the second PRC 22.

Additionally, in the embodiment as illustrated in FIG. 6, the Y component beam travels from the output port 24b of the third PRC 24 to the x input port 24a of the third PRC 24, and from the y output port 14b of the third PRS 14 to the input port 14a of the third PRS 14. In other words, the input and output of the third PRC 24 are also flipped or swapped. As explained above, this can be done because the x-x channel of a PRC is considered to be reciprocal.

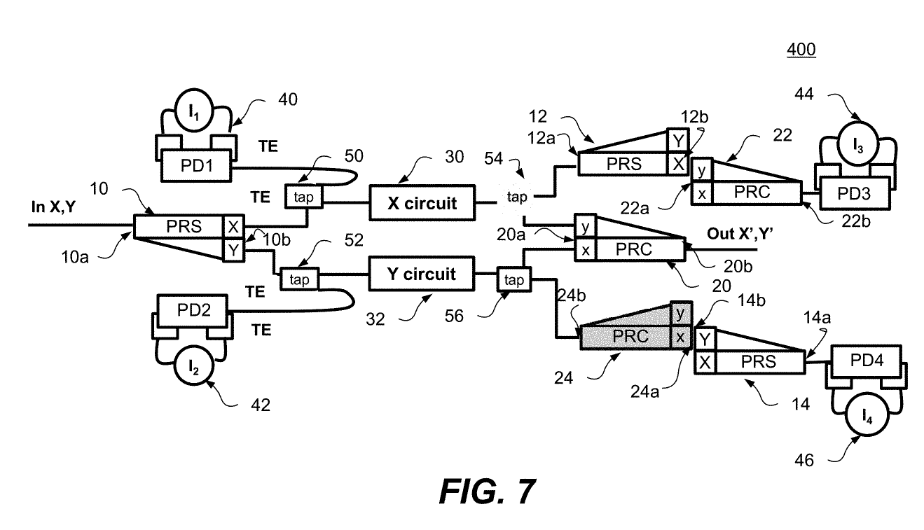

FIG. 7 is a schematic diagram of an optical apparatus 400 for compensating a measurement inaccuracy of PDL, according to yet another alternative embodiment of the disclosure.

In the embodiment as illustrated in FIG. 7, the input and output of the second PRS 12 are connected in the same way as in the embodiment of FIG. 1, but the input and output of the third PRC 24 are flipped or swapped, similar to FIG. 6.

In the embodiments shown by way of FIGS. 1, 5, 6 and 7, the first circuit 30 is coupled to the X output port 10b of the first PRS 10 and the y input port 20a of the first PRC 20, and the second circuit 32 is coupled to the Y output port 10b of the first PRS 10 and the x input port 20a of the first PRC 20. In alternative embodiments, the first PRC 20 can be vertically flipped so that the first circuit 30 is coupled to the X output port 10b of the first PRS 10 and the x input port 20a of the first PRC 20, and the second circuit 32 is coupled to the Y output port 10b of the first PRS 10 and the y input port 20a of the first PRC 20.

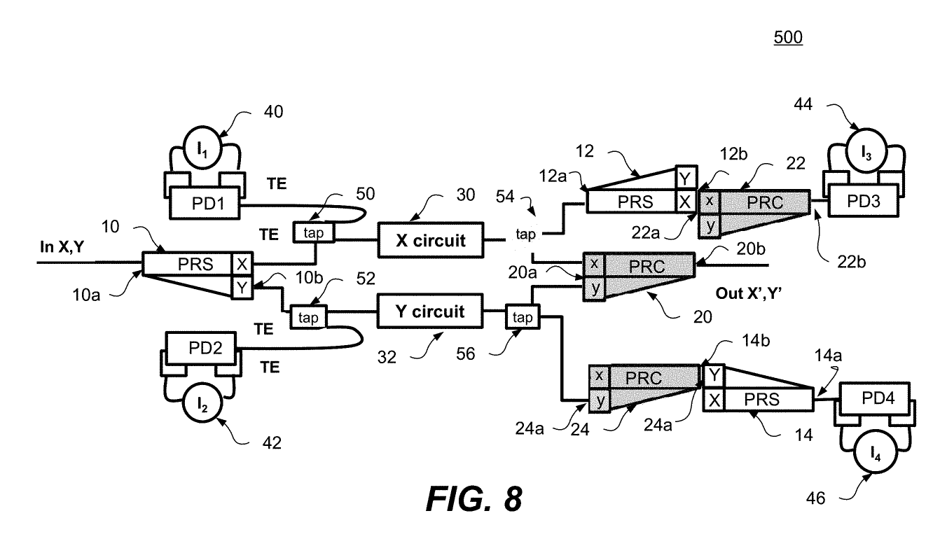

FIG. 8 is a schematic diagram of an optical apparatus 500 for compensating a measurement inaccuracy of PDL, according to one such embodiment.

In the embodiment illustrated in FIG. 8, to maintain the PDL balance in equation (11), the second PRC 22 and the third PRC 24 are arranged such that the X component beam travels through the x input port 22a of the second PRC 22 and the Y component beam travels through the y input port 24a of the third PRC 24. For illustration purposes, the second and third PRCs 22, 24 are shown in FIG. 8 as vertically flipped, in a similar manner as the first PRC 20. It should however be understood that the second and third PRCs 22, 24 do not need to be vertically flipped and it is only the connected ports of the second and third PRCs 22, 24 that matter. As well, the input and output of the second PRS 12 and/or third PRC 24 can be flipped, as described above.

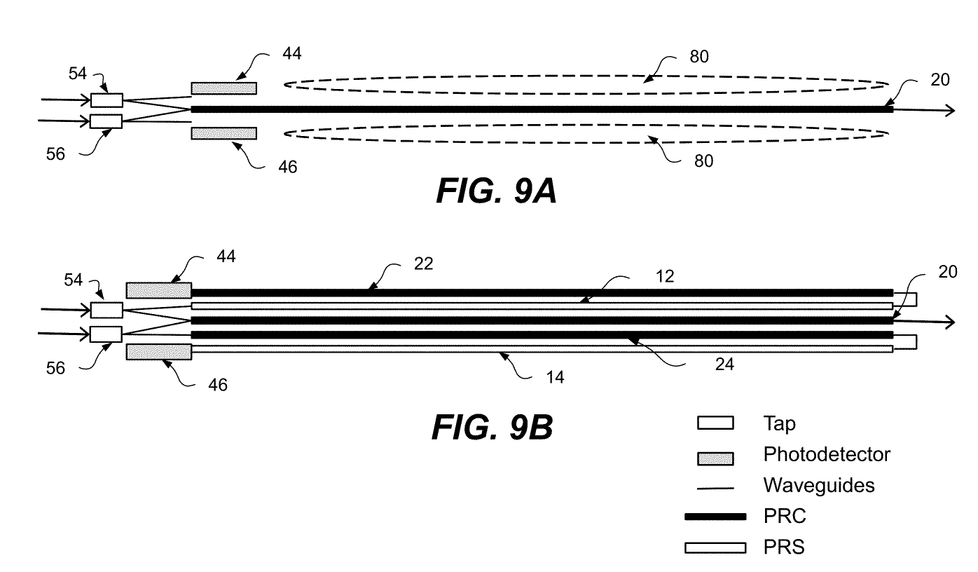

FIG. 9A is a floor plan illustrating an output section of a conventional optical apparatus illustrating the first PRC 20 combining component beams from the optical taps 54, 56. FIG. 9B is a floor plan illustrating an output section of an optical apparatus according to an embodiment of the disclosure, in comparison with FIG. 9A. PRS and PRC can be constructed by very long (e.g., 700 um) and thin (e.g., 15 um) waveguides, which can be much longer than the optical taps (e.g., 30 um) and photodetectors (e.g., 50 um). As illustrated, the dead space 80 in the conventional optical apparatus can be conveniently used by the complementary PRSs 12, 14, and PRCs 22, 24.

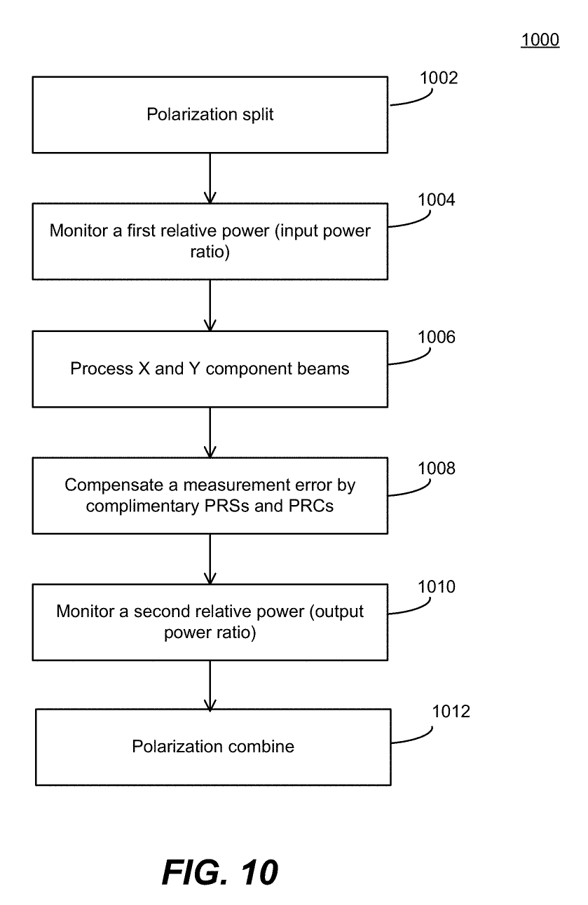

FIG. 10 is a method (1000) of compensating a measurement inaccuracy of PDL in a polarization diverse circuit, according to an embodiment of the disclosure.

The method (1000) includes splitting (1002), by a first PRS, an input beam into orthogonally polarized X and Y component beams. One of the X and Y component beams is rotated to be in the same polarization as the other component beam (such as TE). A first relative power (input power ratio) is monitored (1004) between the X and Y component beams before processing. The X and Y component beams are then processed (1006) separately. A second relative power (output power ratio) is monitored (1010) between the X and Y component beams after processing. A first PRC is used to combine (1012) the X and Y component beams processed respectively by the first and second circuits into an output beam. One of the X and Y component beams is rotated to be orthogonally polarized with respect to the other component beam. As discussed above, a measurement inaccuracy of PDL caused by the first PRS and PRC is compensated (1008) by complementary PRSs and PRCs.

The method can further include calculating a first ratio of a power of the X component beam before processing and a power of the Y component beam before processing; and calculating a second ratio of a power of the X component beam after processing and a power of the Y component beam after processing. The first ratio can be controlled to be equal to the second ratio, by way of adjusting the X, Y circuits.

In actual photonic circuits, the PRS and PRC may depend critically on manufactured dimensions to within 10 nanometers accuracy. The described embodiments enable a more accurate compensation of PDL, tolerant to wafer to wafer variations in sensitive polarization manipulation elements. Such wafer to wafer variations can be more significant than the PDL introduced from fiber to die and/or from die to fiber, which can be controlled by an edge coupler with lower than 0.05 dB PDL. Input and output ratio circuits existing in a conventional optical apparatus can be used and no new electrical circuit is required for the compensation. Copies of PRS and PRC that are already used on the photonic chip can be used and no new optical element is required for the compensation. The additional complementary optical elements (the second and third PSRs, the second and third PRCs) are long and thin waveguides, which can fit neatly adjacent to the existing PRC and PRS in the dead space that is generally not used otherwise for any part of the core photonic circuit.

The described optical apparatuses and methods can be used for in-line optical circuit devices that handle both polarizations, for example, photonic switches, add/drop filters, optical modulators (when they are not co-packaged with lasers). As well, the optical apparatuses and methods according to various embodiments may be used for circuits for polarization-multiplexed signals, or circuits with a signal multiplexed between a random-polarization and a non-polarization, such as an optical interconnect through a traditional single mode fiber.

It is to be understood that the singular forms “a”, “an” and “the” include plural referents unless the context clearly dictates otherwise. Thus, for example, reference to “a device” includes reference to one or more of such devices, i.e. that there is at least one device. The terms “comprising”, “having”, “including” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of examples or exemplary language (e.g., “such as”) is intended merely to better illustrate or describe embodiments of the disclosure and is not intended to limit the scope of the disclosure unless otherwise claimed.

Although several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. An optical apparatus for compensating a measurement inaccuracy of polarization dependent loss (PDL), the apparatus comprising:
a first polarization rotator splitter (PRS) for splitting an input beam into orthogonally polarized X and Y component beams and rotating one of the X and Y component beams to be in the same polarization as the other component beam;
first and second circuits for processing the X and Y component beams respectively;
a first polarization rotator combiner (PRC) for combining the X and Y component beams processed respectively by the first and second circuits into an output beam, one of the X and Y component beams being rotated to be orthogonally polarized with respect to the other component beam;
a first set of photodetectors for monitoring a first relative power between the X and Y component beams before the first and second circuits;
a second set of photodetectors for monitoring a second relative power between the X and Y component beams processed respectively by the first and second circuits; and
complementary PRSs and PRCs coupled between the first and second circuits and the second set of photo-detectors for compensating a measurement inaccuracy of PDL caused by the first PRS and PRC.

2. The optical apparatus of claim 1, wherein the first set of photodetectors comprises a first photodetector for monitoring a power of the X component beam before the first circuit and a second photodetector for monitoring a power of the Y component beam before the second circuit; and
the second set of photodetectors comprises a third photodetector for monitoring a power of the X component beam processed by the first circuit and a fourth photodetector for monitoring a power of the Y component beam processed by the second circuit.

3. The optical apparatus of claim 2, further comprising optical taps optically coupled to each of the first, second, third and fourth photodetectors for tapping a fraction of light.

4. The optical apparatus of claim 2, wherein the complementary PRSs and PRCs include a second PRS and second PRC coupled between the first circuit and the third photodetector; and a third PRS and third PRC coupled between the second circuit and the fourth photodetector.

5. The optical apparatus of claim 4, wherein the second and third PRSs are substantially identical to the first PRS, and wherein the second and third PRCs are substantially identical to the first PRC.

6. The optical apparatus of claim 5, wherein each of the first, second, and third PRSs includes an input port, and X and Y output ports; and each of the first, second, and third PRCs includes x and y input ports and an output port; and
the first circuit is coupled to the X output port of the first PRS and the y input port of the first PRC, and the second circuit is coupled to the Y output port of the first PRS and the x input port of the first PRC.

7. The optical apparatus of claim 6, wherein the X component beam travels through the X output port of the second PRS and the Y input port of the second PRC; and the Y component beam travels through the X input port of the third PRC and the Y output port of the third PRS.

8. The optical apparatus of claim 7, wherein the X component beam travels from the input port of the second PRS to the X output port of the second PRS, and from the Y input port of the second PRC to the output port of the second PRC.

9. The optical apparatus of claim 7, wherein the X component beam travels from the X output port of the second PRS to the input port of the second PRS, and from the Y input port of the second PRC to the output port of the second PRC.

10. The optical apparatus of claim 7, wherein the Y component beam travels from the X input port of the third PRC to the output port of the third PRC, and from the Y output port of the third PRS to the input port of the third PRS.

11. The optical apparatus of claim 7, wherein the Y component beam travels from the output port of the third PRC to the X input port of the third PRC, and from the Y output port of the third PRS to the input port of the third PRS.

12. The optical apparatus of the claim 1, wherein the first PRS and the first PRC are not reciprocal.

13. The optical apparatus of claim 2, wherein the first set of photodetectors are TE photodetectors, and the second set of photodetectors are TM photodetectors.

14. The optical apparatus of claim 12, wherein the TE photodetectors are identical to the TM photodetectors.

15. The optical apparatus of claim 2, further comprising a control circuit for controlling the X and Y circuits to maintain a balance between the first relative power and the second relative power.

16. The optical apparatus of claim 15, wherein the first relative power is calculated based on a ratio of the power of the X component beam before the first circuit and the power of the Y component beam before the second circuit; and
the second relative power is calculated based on a ratio of the power of the X component beam processed by the first circuit and the power of the Y component beam processed by the second circuit.

17. The optical apparatus of claim 16, wherein the control circuit controls the X and Y circuits for the first relative power to be equal to the second relative power.

18. A method of compensating a measurement inaccuracy of polarization dependent loss (PDL) in a polarization diverse circuit, the method comprising:
splitting, by a first polarization rotator splitter (PRS), an input beam into orthogonally polarized X and Y component beams, one of the X and Y component beams being rotated to be in the same polarization as the other component beam;
monitoring a first relative power between the X and Y component beams before processing;
processing the X and Y component beams separately;
monitoring a second relative power between the X and Y component beams after processing; and
combining, by a first polarization rotator combiner (PRC), the X and Y component beams processed by the first and second circuits into an output beam, one of the X and Y component beams being rotated to be orthogonally polarized with respect to the other component beam,
wherein a measurement inaccuracy of PDL caused by the first PRS and PRC is compensated by complementary PRSs and PRCs.

19. The method of claim 18, wherein the complementary PRSs and PRCs are substantially identical to the first PRS and PRC, respectively.

20. The method of claim 19, further comprising calculating a first ratio of a power of the X component beam before processing and a power of the Y component beam before processing;
and calculating a second ratio of a power of the X component beam after processing and a power of the Y component beam after processing.

21. The method of claim 19, further controlling the first ratio to be equal to the second ratio.
